(19) United States
(12) Patent Application Publication
(10) Pub. No.: US 2010/0327155 A1
(43) Pub. Date: Dec. 30, 2010

(54) Micro-plasma Illumination Device and Method

(75) Inventors: Viorica Lopez-Avila, Sunnyvale, CA (US); Arthur Schleifer, Portola Vally, CA (US); Stuart Hansen, Palo Alto, CA (US)

Correspondence Address: Agilent Technologies, Inc. in care of:;CPA Global, P. O. Box 52050, Minneapolis, MN, 55402, US

(73) Assignee: Agilent Technologies, Inc., Loveland, CO (US)

(21) Appl. No.: 11/932,835

(22) Filed: Oct. 31, 2007

(51) Int. Cl. B01D 59/44; H05H 1/24

(52) U.S. Cl. 250/282; 250/288; 315/111.21

(57) ABSTRACT

An illumination method and device has a micro-wave powered plasma source contained by a windowless plasma containment structure. When incorporated as a photo-ionization device in an ion mobility spectrometer (IMS), the resolution of the spectrometer may be improved by operation at higher pressures and through selective ionization of elements and compounds. A gas flows into a discharge gap of a micro-wave ring resonator, but is restricted from flowing away by the windowless containment structure. When microwave power is supplied, the discharge gap is energized and a plasma initiated and sustained. Photons emitted by the plasma photo-ionize a sample gas. As the containment structure is windowless, the wavelength of the emitted radiation depends on the plasma-forming gas, not on the transmission characteristics of a window material. The range of substances in the sample that are ionized may be influenced by selecting the plasma-forming gas.

### BACKGROUND

Since 9/11, there has been an increased effort to screen passengers and cargo for explosives, narcotics and chemical warfare agents in all forms of transport. The primary technology deployed to do the screening at airports has been ion mobility spectrometry.

Ion mobility spectrometry is a relatively simple technology that is robust and moderately priced, yet capable of detecting and identifying very low concentrations of organic chemicals.

An ion mobility spectrometer (IMS) operates by measuring the differential migration of gas phase ions in a homogeneous electric field gradient through a given atmosphere. In order to do this, the molecules of the sample first need to be ionized. This is typically accomplished in an ionization chamber by either corona discharge, atmospheric pressure photoionization (APPI), electrospray ionization (ESI), or a radioactive source such as a small piece of radioactive nickel (₆₃Ni). The ions are then allowed into a drift tube by means of an ion shutter that operates like the grid of a triode vacuum tube. The drift tube has a uniform electric field gradient that propels the ions toward a collector electrode. The drift tube is filled with a drift gas. Consequently, the transit time of an ion along the drift tube from the ionization chamber to the collection electrode depends on the size and shape of the ion as well as its mass-to-charge ratio. The resolution of an IMS, therefore, increases with increased drift tube length, increased electric field gradient and increased drift gas pressure. The selectivity of an IMS may also be increased by using an ionizing source that selectively ionizes chemicals of interest.

In a typical IMS such as the Itemiser™ spectrometer supplied by GE Ion Track Inc. of Wilmington, Mass., the length of the drift tube is approximately 4 cm, the operating voltage is approximately 1000 Volts, supplying a uniform electric field gradient of 250 V/cm, and the pressure in the drift tube is in the range of 700 Torr, i.e., slightly less than atmospheric pressure.

Despite its advantages, ion mobility spectrometry does have short comings. The first is the sample collection. In order to have a sample that is sufficiently large for positive identification, it is usually necessary to take a surface swab of the object being tested. Although effective, swabbing limits throughput to about one sample every 30 seconds. This is too slow if, for instance, there is a desire to screen every person entering an airport terminal, or attending a football game.

An alternative to swabbing is to collect vapor or airborne particulate material using some form of vacuuming. The low vapor pressures of some drugs and explosives, however, make it difficult to collect an adequate amount of sample in a sufficiently concentrated form, given the sensitivity and resolution of a typical IMS.

A second problem is the high level of false positives. For instance, there are some hand creams that produce false positives for the explosive, TNT.

Any method for improving the resolution or sensitivity of an IMS so as to allow the use of significantly smaller samples or to reduce the number of false positives is, therefore, highly desirable.

In particular, any illumination source that may be used in an IMS to improve the resolution or sensitivity is of great interest.

### BRIEF DESCRIPTION OF THE DRAWINGS

FIG. 1 shows a schematic cross-sectional view of an exemplary embodiment of a micro-plasma illumination device in accordance with the invention.

FIG. 2 is a flow diagram illustrating an example of an illumination method in accordance with the invention.

FIG. 3 shows a more detailed schematic cross-sectional view of an exemplary embodiment of a micro-plasma illumination device in accordance with the invention.

FIG. 4A shows a schematic plan view of a microwave ring-resonator as prepared for incorporation into an exemplary embodiment of a micro-plasma illumination device in accordance with the invention.

FIG. 4B shows a schematic plan view of the microwave ring-resonator shown in FIG. 4A with a windowless plasma containment structure in place.

FIG. 5 shows a schematic cross-sectional view taken at line 5-5 of FIG. 4B.

FIG. 6 shows a schematic cross-sectional view of a multi-parallel micro-plasma photo ionization device in accordance with the invention.

### DETAILED DESCRIPTION

The invention relates to illumination devices, particularly microwave powered plasma illumination sources, and their applications. In particular, the invention relates to a microwave powered plasma illumination source in which a plasma is contained by a windowless plasma containment structure. Such an illumination source is particularly suitable for use in ionizing samples in a portable, or miniaturized, ion mobility spectrometer (IMS). Such a source, for instance, allows the resolution of the IMS to be improved by operating the IMS at a higher pressure and through the selective ionization of elements and compounds in samples introduced into the IMS.

In one embodiment, the illumination device includes a stripline ring resonator that defines a discharge gap. A plasma-forming gas is flowed into the discharge gap, but a windowless containment structure impedes the plasma-forming gas from flowing away from the discharge gap. Microwave power is then supplied to the stripline resonator, energizing the gap and converting the plasma-forming gas to a photon-emitting plasma.

Such an illumination device may additionally be used in a variety of applications including, but not limited to, ultra-violet (UV) photo-lithography and UV spectroscopy. The illumination device, however, is particularly well suited to improving the performance of an IMS. When used in an IMS, photons emitted by the plasma may be used to photo-ionize a chemical element, or compound, in a sample gas. The ionized chemical element or compound may then be identified by measuring its transit time through a drift gas over a known path in a drift tube.

The windowless containment structure allows the plasma to be initiated and maintained substantially independent of pressure external to the containment structure. When incorporated in an IMS, this allows the drift tube of the IMS to be operated at greater than atmospheric pressure, improving the resolution of the IMS.

A windowless containment structure is a containment structure that impedes the flow of plasma-forming gas using baffles so that a plasma can be established and maintained therein and does so without transmitting light generated by the plasma through a solid window material that would modify the spectrum of such light. The wavelength and energy of the photons generated by the plasma and output from the windowless containment structure are not limited by the transmission characteristics of any window material. Instead, the wavelength and energy of the photons output from the windowless containment structure depends solely on the properties of the plasma-forming gas used to generate the plasma. The range of substances in the sample that are ionized may, therefore, be determined by selecting an appropriate plasma-forming gas.

Microwave generated plasmas (also known as microplasmas) have many advantages as photon sources. Microwave plasma generators are cheap to operate, having low gas and power consumption. Microwave plasma generators can be mass produced and, due to their small size, they allow for parallel operation of multiple microplasmas in a single device. For instance, a device may effectively be several IMSs operating in parallel, each having its own microplasma ionization source with a different plasma-forming gas and producing a different spectral output that selectively ionizes different elements or compounds, or classes of elements or compounds.

Miniaturized plasma sources have been described in, for instance, United States Patent publication No. 20050195393, submitted by Vassili Karanassios entitled “Miniaturized Source Devices for Optical and Mass Spectrometry,” and in a Review article entitled “Microplasmas for Chemical Analysis: Analytical Tools or Research Toys?” published by Vassili Karanassios in Spectrochimica Acta Part B 59, pp 909-928 (2004).

Low power microwave plasma generators have been described in detail in, for instance, U.S. Pat. No. 6,917,165 issued to Hopwood et al. entitled “Low Power Plasma Generator.” Hopwood describes a plasma generator in which a plasma is generated within a glass tube bonded to a substrate at one end and coupled to a supply of plasma-forming gas at the other end. The usable photons emitted by Hopwood's device are, therefore, limited in wavelength to the range of wavelengths transmitted by the glass or other material of which the tube is made. Tubes made of the optical materials that are known to be most transparent to ultra-violet (UV) light such as CaF₂, MgF₂ or LiF, transmit photons with maximum energies of 9.8 eV, 10.6 eV and 11.7 eV respectively. These tube materials limit the range of substances that can be photo-ionized to those that have ionization potentials less than 11.7 eV. The ionization potential of the elements ranges from 3.83 eV to 24.59 eV. Many of the important light elements have ionization potentials in excess of 11.7 eV. These elements include, but are not limited to, bromine (11.8 eV), chlorine (12.97 eV), hydrogen (13.6 eV), oxygen (13.62 eV), nitrogen (14.5 eV), fluorine (17.4 eV) and helium (24.59 eV). Hopwood's device would, therefore, be unable to photo-ionize these important elements.

Although ion mobility spectrometry is a very sensitive and robust technique, it suffers from poor resolution compared to conventional, laboratory based mass spectrometry. This is especially true of miniaturized IMS devices. As mentioned above, the resolution of an IMS device may be improved by increasing the length of the drift tube, increasing the operating electric field gradient and increasing the operating pressure.

The resolution may also be improved by judicious use of a source that selectively ionizes different elements. Improving the sensitivity of an ion mobility spectrometer using selective photo-ionization has been described in, for instance, U.S. Pat. No. 6,509,562 issued to Yang et. al. entitled “Selective Photo-ionization Detector using Ion Mobility Spectrometry.”

Yang describes the use of sealed UV lamps having windows made of Al₂O₃, CaF₂, MgF₂ or LiF so that they transmit photons with maximum energies of 8.4 eV, 9.8 eV, 10.6 eV and 11.7 eV respectively. These UV lamps are used to selectively photo-ionize samples in the sample chamber of an ion mobility spectrometer. The highest ionization energy obtainable with a sealed UV lamp is, however, limited by the window material to about 11.7 eV. This means that such a device would be unable to ionize the same light elements as Hopwood's device, described above. Many of these elements are important in detecting, or discriminating, explosives, narcotics and chemical warfare agents.

Examples of an illumination device, an illumination method and an ion mobility spectrometer in accordance with various embodiments of the invention will now be described in detail by reference to the accompanying drawings in which, as far as possible, like elements are designated by like numbers. The accompanying drawings are, however, not necessarily drawn to scale.

FIG. 1 is a schematic, cross-sectional view of an exemplary embodiment of an illumination device in accordance with the invention in which a photon-emitting microwave powered plasma is contained in a windowless plasma containment structure 12.

A stripline ring resonator 40 defines a discharge gap 42. The windowless plasma containment structure 12 defines a plasma chamber 54 that has an inlet aperture 58 and an outlet aperture 56. The inlet aperture 58 faces the discharge gap 42. An inlet vent 20 extends into the discharge gap 42. The inlet vent 20 is capable of outputting a plasma-forming gas 19 into the containment structure 12. Microwave power supplied to the stripline ring resonator 40, converts the plasma-forming gas 19 into a photon-emitting plasma 64 emitting photons 27. In the example shown, the inlet vent 20 extends through a substrate 14 that supports the stripline ring resonator 40 and has a centerline 63 that lies within the discharge gap 42. In other examples, the inlet vent is located in the vicinity of the discharge gap 42 so that the plasma-forming gas can flow into the discharge gap.

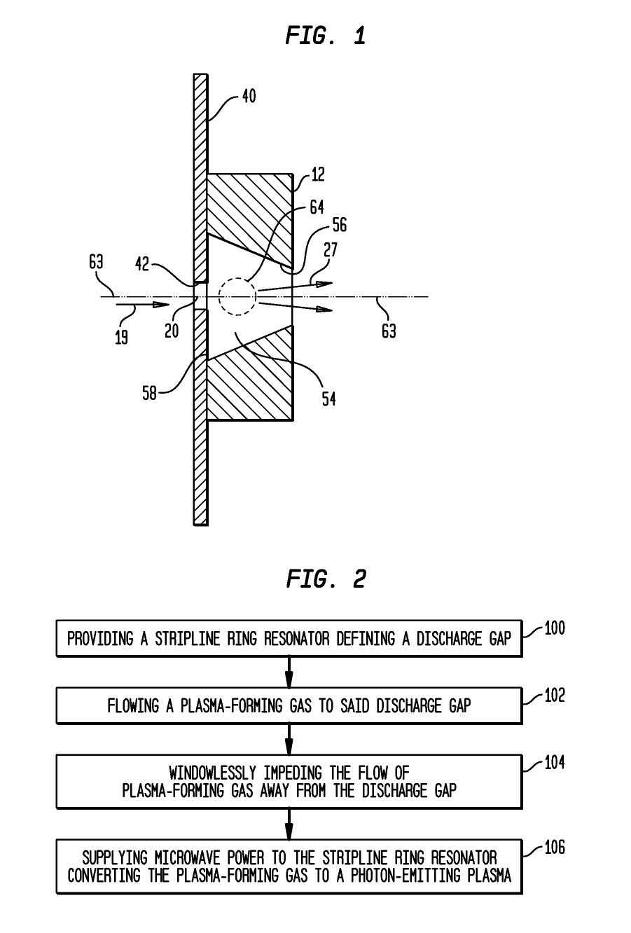

FIG. 2 is a flow diagram illustrating an example of a method in accordance with the invention.

In block 100, a stripline ring resonator that defines a discharge gap is provided. Both the stripline ring resonator and discharge gap are described in more detail below.

In block 102, plasma-forming gas is flowed into the discharge gap. The advantages of using different types of plasma-forming gas 19 are described in detail below.

In block 104, the flow of the plasma-forming gas away from the discharge gap is windowlessly impeded. Windowlessly impeding the flow of the plasma-forming gas allows a plasma to be established and maintained in the plasma-forming gas over a wide range of pressure external to the plasma-forming gas, and additionally allows light generated by the plasma to be emitted without the filtering effect of a solid window material. For example, when the method is performed to ionize the sample in an ion-mobility spectrometer, windowles sly impeding the flow of the plasma-forming gas allows the plasma to be established and maintained in the plasma-forming gas over a wide range of pressure of the drift gas. Windowles sly impeding the flow of plasma-forming gas allows conditions favorable to the establishment and maintenance of plasmas to be obtained independently of the environment in which the illumination device is operating.

In block 106, microwave power is supplied to the stripline ring resonator. The microwave power converts the plasma-forming gas to a photon-emitting plasma. Since the flow of the plasma-forming gas is windowlessly impeded, photons emitted by the photon-emitting plasma are unimpeded by the transmission characteristics of any window material through which the photons would otherwise be transmitted. The usable wavelengths of photons available from such illumination method, therefore, depend primarily on the properties of the plasma-forming gas, as described in detail below.

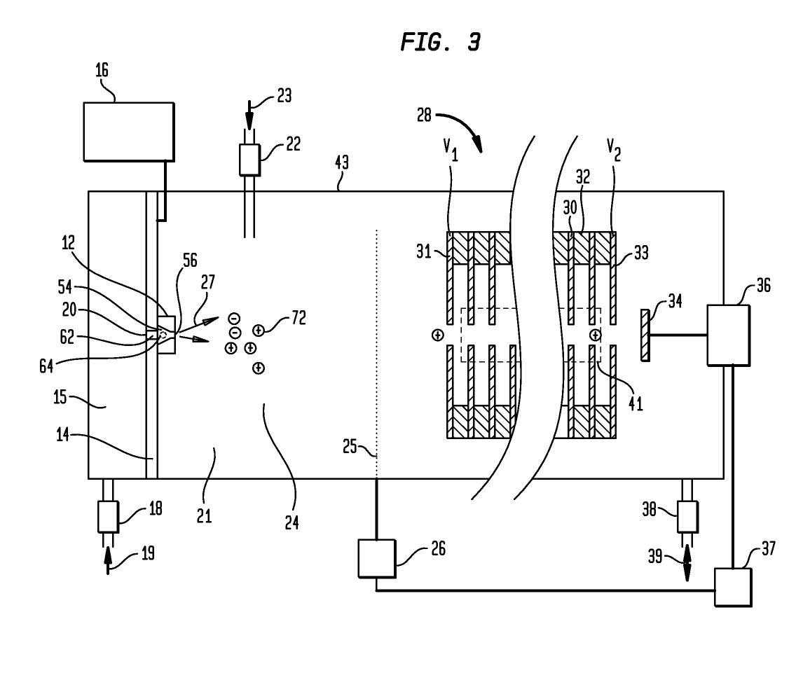

FIG. 3 is a schematic view of an exemplary embodiment of an illumination device in accordance with the invention in which a microwave powered plasma generated in a windowless plasma containment structure 12 is incorporated in an ion-mobility spectrometer 10.

The windowless plasma containment structure 12 is mounted on a substrate 14. The windowless plasma containment structure 12 cooperates with the substrate 14 to define the plasma chamber 54. Power for generating a plasma is supplied by a microwave power supply 16 electrically connected to a stripline located on substrate 14. Plasma-forming gas 19 for the plasma is supplied to a plasma-forming gas chamber 15 via a plasma-forming gas inlet valve 18. From the plasma-forming gas chamber 15, the plasma-forming gas 19 is directed into the plasma chamber 54 via a plasma-forming gas inlet vent 20 that passes through the substrate 14. The plasma-forming gas inlet vent 20 extends into the plasma chamber 54 via a vent aperture 62. The plasma-forming gas 19 is restricted from leaving the plasma chamber 54 by an exit aperture 56 defined by containment structure 12. Exit aperture 56 restricts the flow of the plasma-forming gas 19 out of the plasma chamber 54 and away from the vent aperture 62, which allows the pressure of the plasma-forming gas 19 in the plasma chamber 54 to be controlled. In this way, the appropriate pressure may be maintained within plasma chamber 54 so that, when microwave power is supplied to a stripline ring resonator 40 (not shown in FIG. 3), a photon-emitting plasma 64 is formed in the vicinity of the vent aperture 62, as will be described in detail below.

By making the plasma containment structure 12 windowless, photons 27 emitted by the plasma travel through the exit aperture 56 to an external region 21 unimpeded by the transmission characteristics of any barrier material. In the ion-mobility spectrometer 10, the external region 21 is typically termed an ionization chamber 24.

A sample gas 23 is introduced into the ion-mobility spectrometer 10 via a sample gas inlet valve 22. The sample gas arrives at the ionization chamber 24 where it is exposed to the photons 27 emitted by the plasma contained in the plasma chamber 54 by the windowless plasma containment structure 12, producing sample ions 72. The sample ions 72 may be ionized molecules, ionized atoms, or both.

As the plasma containment structure 12 is windowless, there is no barrier material having transmission properties that limit the wavelength of the photons 27 reaching the sample gas 23 from the plasma 64. The wavelength of the photons 27 that ionize the compounds and elements contained in the sample gas 23 depends solely on the properties of the plasma-forming gas 19. In an example in which the plasma-forming gas 19 is helium, the plasma 64 emits photons 27 having a wavelength in a range of 58 nm to 60 nm. Such photons are capable of ionizing a substance in ionization chamber 24 that have an ionization potential of up to 22 eV. In an example in which the plasma-forming gas 19 is argon, the plasma 64 emits photons 27 having a wavelength in a range of 104 nm to 108 nm. Such photons are capable of ionizing a substance the ionization chamber 24 having an ionization potential of up to 12 eV. In an example in which the plasma-forming gas 19 is krypton, the plasma 64 emits photons 27 having a wavelength in a range of 116 nm to 125 nm. Such photons are capable of ionizing a substance in the ionization chamber 24 having an ionization potential of up toll eV. In an example in which the plasma-forming gas 19 is xenon, the plasma 64 emits photons 27 having a wavelength in a range of 145 nm to 150 nm. Such photons are capable of ionizing a substance in the ionization chamber 24 having an ionization potential of up to 9 eV.

The sample ions 72 enter a drift tube 28 via an ion shutter grid 25 that is controlled by an ion shutter control circuit 26. The drift tube 28 typically comprises a number of annular conducting electrodes 30 separated by annular resistive spacers 32. A voltage is applied between a collector end of the drift tube 33 and an ionization chamber end of the drift tube 31, resulting in a substantially uniform electric field gradient in the vicinity of the opening of the annular conducting electrodes 30 along a drift region 41 within the drift tube 28. The sample ions 72 of the appropriate polarity that are allowed into the drift tube 28 by the ion shutter grid 25 travel to a collector electrode 34. When the sample ions arrive at the collector electrode 34, their arrival is recorded by an ion detector electronic module 36. The drift tube 28 is filled with a drift gas 39, typically a relatively inert gas such as nitrogen. The transit time for the sample ions 72 to travel from the ion shutter grid 25 to the collector electrode 34 is, therefore, dependent on its size and shape of the sample ions 72 as well as their mass-to-charge ratio. The ion detector electronic module 36 and the ion shutter control circuit 26 are typically both controlled by a device control unit 37. In this way, the ion shutter grid 25 may be operated in cooperation with the collector electrode 34 to time the passage of the sample ions 72 through the drift region 41 as described below.

The drift tube 28 may operate with either a positive or a negative polarity voltage applied between the ionization chamber end 31 of the drift tube 28 and the collector end 33 of the drift tube 28. When the collector end 33 of the drift tube 28 is more positive relative to ionization chamber end 31, negatively-charged ions will be accelerated towards the collector electrode 34. When the collector end 33 of the drift tube 28 is more negative than ionization chamber end 31, positively-charged ions will be accelerated towards the collector electrode 34.

A drift tube control valve 38 may control both the supply of the drift gas 39 to the drift region 41 and allow excess sample gas 23 and excess plasma-forming gas 19 to exit the ion-mobility spectrometer 10.

FIG. 6 shows an example of a multi-parallel micro-plasma 70 device in accordance with the invention. The multi-parallel micro-plasma 70 has two plasma-forming gas chambers 15 each of which is supplied with a different plasma-forming gas 19. The plasmas generated in the two windowless plasma containment structures 12 emit photons of different wavelength. The sample gases 23 entering the respective ionization chambers 24 are subject to different ionization. The drift gas 39 in the two or more drift tubes 28 may be the same gas at the same or different pressures, or it may be different gases at the same or different pressures. In this way the sample ions 72 collected at the two collector electrodes 34 may be resolved at a greater resolution than using a simple ion-mobility spectrometer. Other examples have more than two plasma-forming gas chambers 15, each receiving a supply of a respective plasma-forming gas 19, and the same number of plasma containment structures 12, ionization chambers 24, and collector electrodes 24.

In further embodiments of the IMS shown in FIG. 3, the sample gas inlet valve 22 may, for instance, be interfaced with a flow injection, or a nebulizer coupled with a desolvation unit, for sample introduction from a chromatographic column.

In a multi-parallel microplasmas IMS device shown in FIG. 6, there may be several sample gas inlet valves 22, each interfaced with a flow injection, or a nebulizer coupled with a desolvation unit, for sample introduction from multiple chromatographic columns.

The drift tube 28 shown in FIG. 3 is enclosed in a pressurized tube 43 and is operated a pressure of about atmospheric pressure. This relatively high pressure is particularly beneficial for a miniaturized IMS.

In a typical ion-mobility spectrometer, as shown in FIG. 3, the drift tube 28 is approximately 4 cm in length, the voltage between the ionization chamber end of the drift tube 31 and collector end of the drift tube 33 is approximately 1000 Volts, resulting in a uniform electric field gradient of 250 V/cm. A heater (not shown) maintains the drift tube 28 at a temperature of approximately 200 degrees centigrade. The pressure in the drift tube 28 is in typically in the range of 700 Torr. Ion-mobility spectrometers 10 can operate under a wide range of conditions and there specific numbers quoted above are merely one example of size and operating conditions and are in no way intended to be limiting.

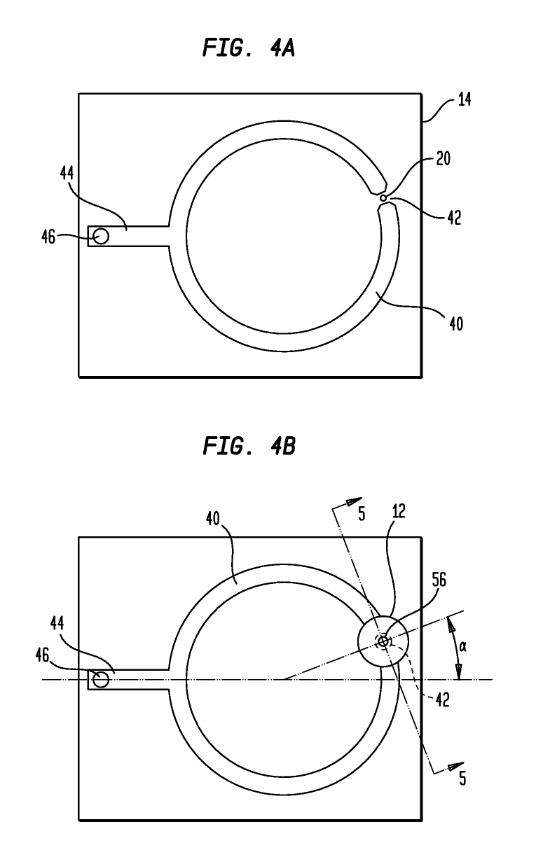

FIG. 4A is a plan view of the stripline ring resonator 40 mounted on the substrate 14. The stripline ring resonator 40 has the discharge gap 42 in which is located the plasma-forming gas inlet vent 20. The stripline ring resonator 40 is connected to a microwave power input connector 46 by a quarter-wavelength stripline 44. The circumference of the stripline ring resonator 40 is equal to one half-wavelength at the operating frequency.

FIG. 4B is a plan view of the stripline ring resonator 40 with the windowless plasma containment structure 12 in place. The offset angle α between the centerline of the quarter wavelength stripline 44 and the location of the discharge gap 42 in the circumference of the stripline ring resonator 40 is selected so that the combined impedance of the stripline ring resonator 40 and the quarter wavelength stripline 44 matches the impedance of the microwave power supply 16 (FIG. 3) that energizes the device. The impedance is typically 50 ohms. The voltages at the discharge gap 42 end of the stripline ring resonator 40 are nearly 180 degrees out of phase, and in combination with the resonance of the ring, create an intense electric field across the discharge gap 42.

In an exemplary embodiment, the stripline ring resonator 40 is about 7 mm in diameter and operates at a frequency of 2.4 GHz. The offset angle α between the centerline of the quarter wavelength stripline 44 and the discharge gap 42 is typically between 10 and 14 degrees. Other examples have other dimensions optimized, for instance, for other microwave power frequencies.

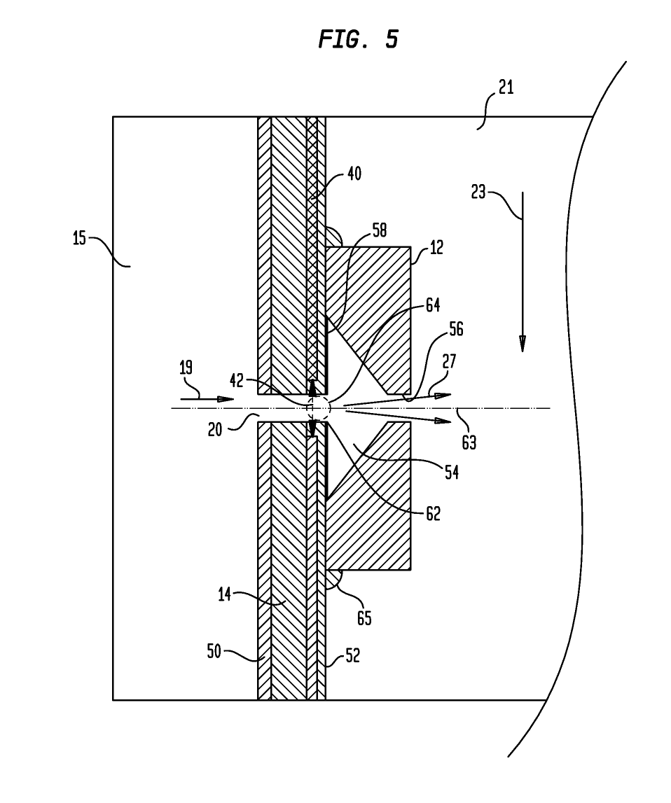

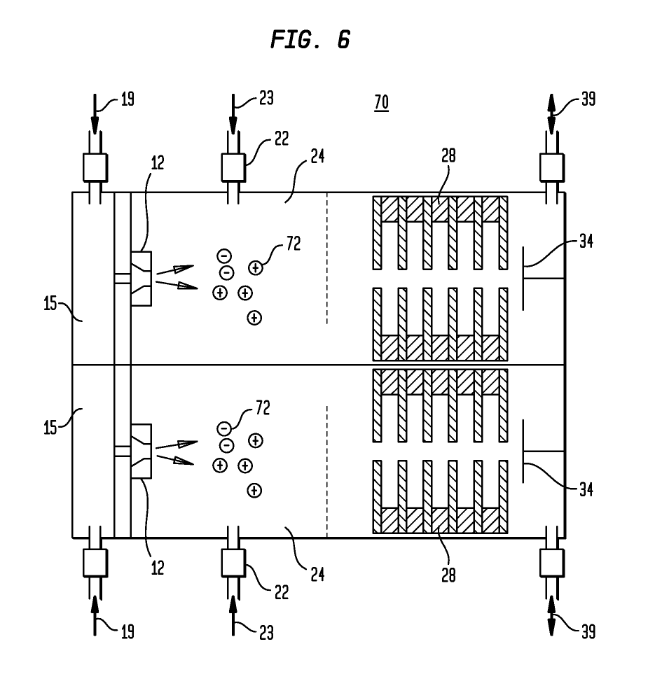

FIG. 5 is a schematic cross-sectional view of an exemplary windowless plasma containment structure 12 attached to the stripline ring resonator 40. The cross-section is taken on line “5-5” of FIG. 4B.

The stripline ring resonator 40 is mounted on one side of the substrate 14. A backplane 50 is mounted on the other side of the substrate 14. The backplane 50 acts in cooperation with the stripline ring resonator 40 and the dielectric substrate 14 to form a waveguide structure through which microwaves may propagate. The stripline ring resonator 40 is covered by an insulating layer 52. The windowless plasma containment structure 12 is mounted on the same side of the substrate 14 as the stripline ring resonator 40. The windowless plasma containment structure 12 may be bonded to the substrate 14 by one or more adhesive beads 65, comprised of, for instance, vacuum epoxy. The plasma-forming gas 19 enters from the backplane 50 side of the substrate 14 through the gas inlet vent 20 that extends from the backplane 50 to the vent aperture 62 located on the stripline ring resonator 40 side of the substrate 14. The plasma-forming gas 19 enters and exits the plasma chamber 54 through the inlet aperture 58 and the exit aperture 56, respectively, defined in the windowless plasma containment structure 12.

By selection of the relative sizes of the vent aperture 62 and the exit aperture 56 and the inlet pressure of the plasma-forming gas 19, difference between pressure of the plasma-forming gas within the plasma chamber 54 and the pressure in the external region 21 beyond the exit aperture 56 may be made relatively independent of the pressure in the external region 21.

In an example in which the pressure in the external region 21 is low, e.g., significantly less than 1 Torr, the plasma-forming gas chamber 15 is typically at pressure of about 70 Torr, the discharge gap 42 has a width of about 1 mm, the vent aperture 62 has a diameter of the order of 300 μm, the exit aperture 56 has a diameter of about 200 μm, and the plasma-forming gas 19 flows through the vent aperture 62 at a rate of about 2-4 ml/minute. This results in the plasma-forming gas 19 in the plasma chamber 54, in the vicinity of the vent aperture 62, having a pressure of about 1 Torr. This pressure and rate of flow of plasma-forming gas 19 is sufficient to initiate and maintain a microwave powered plasma when microwave power is supplied to the microwave ring resonator 40.

In an example in which the pressure in the external region 21 is high, e.g., closer to atmospheric pressure (760 Ton), a pressure difference similar to that in the low-pres sure example described above is maintained between the plasma-forming gas chamber 15 and the external region 21. In an example, the plasma-forming gas chamber 15 is maintained at a pressure of about 830 Ton. Such pressure difference establishes a flow rate of the plasma-forming gas similar to that in the low-pressure example. With the plasma-forming gas chamber 15 at a pressure of about 830 Torr, the pressure of the plasma-forming gas 19 in the plasma chamber 54 is between 780 and 810 Ton, which is also higher than that in the low-pressure example described above. To initiate and maintain a microwave powered plasma at this increased pressure, the discharge gap 42 is smaller than in the low-pressure example.

By selectively changing the variables detailed above, the appropriate conditions may be obtained so that, when the stripline ring resonator 40 is energized by the microwave power supply 16 (FIG. 3), a plasma 64 is initiated and maintained within the plasma chamber 54 in the vicinity of the vent aperture 62, as described below. The plasma emits photons 27 that radiate out of the windowless containment structure 12 through the exit aperture 56, unimpeded by any window material.

The exit aperture 56 is typically centered on the centerline 63 of the plasma-forming gas inlet vent 20 and the vent aperture 62. This centers the exit aperture 56 with respect to the discharge gap 42. This maximizes the number of photons 27 generated by the plasma that reach the external region 21, while providing maximum restriction of the flow of plasma-forming gas 19 away from the vent aperture 62.

In a preferred embodiment, the substrate 14 comprises a ceramic dielectric material, the windowless plasma containment structure 12 comprises a sapphire jewel material and the insulating layer 52 comprises a glass material.

In an exemplary embodiment, the plasma chamber 54 defined by containment structure 12 is conical and has a height of about 0.6 mm, the inlet aperture 58 has a diameter of about 1 mm, and the exit aperture 56 has a diameter of about 0.2 mm and a length of about 0.2 mm.

The operation of an example the IMS 10 in accordance with the invention will now be described with reference to FIG. 3. In operation, the microwave power supply 16 is typically tuned to the resonant frequency of the stripline ring resonator 40 (FIG. 4A and FIG. 4B). Alternatively, the frequency of the microwave power supply 16 is preset to a frequency at or near the resonant frequency of the stripline ring resonator. The plasma-forming gas 19 is introduced into the plasma-forming gas chamber 15 via the plasma-forming gas inlet valve 18. The pressure of the plasma-forming gas 19 in the plasma-forming gas chamber 15 is typically higher than the pressure of the sample gas 23 in the ionization chamber 24 and the pressure of the drift gas 39 in the drift tube 28. The plasma-forming gas 19 flows through the plasma-forming gas inlet vent 20 into the plasma chamber 54. The windowless plasma containment structure 12 impedes flow of the plasma-forming gas 19 away from the vicinity of the vent aperture 62. In particular, the diameter of the exit aperture 56 defined by the windowless containment structure is wide enough to allow photons 27 emitted by the plasma to exit, but narrow enough to restrict the flow of plasma-forming gas 19 away from the vent aperture 62. The flow restriction maintains the plasma-forming gas 19 at an appropriate pressure of between 10 Torr and 700 Torr in the vicinity of the vent aperture 62. A pressure in this range allows a stable plasma 64 to be formed when the discharge gap 42 is energized. If the pressure in the ionization chamber 24 is low, as in the low-pressure example described above, the exit aperture 56 is typically smaller than the vent aperture 62. To minimize the flow of the plasma-forming gas 19, both apertures are typically of the order of 200 μm in diameter. If the pressure in the ionization chamber 24 is about atmospheric pressure, as in the high-pressure example described above, the diameter of the exit aperture 56 may be substantially equal to the diameter of the vent aperture 62 and the pressure in the plasma-forming gas chamber 15 may be only slightly higher than atmospheric pressure.

The plasma 64 generated in the vicinity of the vent aperture 62 typically occupies a region ranging from about 0.5 times to about 4 times the diameter of the vent aperture 62 and extending into the plasma-forming gas inlet vent 20 as well as into the plasma chamber 54. Although shown schematically as approximately spherical, the region occupied by the plasma 64 may be asymmetric, including plume like, and may oscillate or change in position, size and shape with time.

Once the flow of plasma-forming gas 19 is started through the plasma-forming gas inlet vent 20 and power is applied to the stripline ring resonator 40, the plasma 64 is typically self striking. This means that there is no need to add a striking voltage and then reduce the power for operation. Nor is there, typically, a need for an outside stimulus such as, but not limited to, a spark, to start the plasma.

The microwave powered, photon-emitting plasma 64 located in the vicinity of the vent aperture 62 emits photons 27 having a wavelength that depends on the properties of the plasma-forming gas 19, as detailed above. Such a microwave powered, photon-emitting plasma may be used as an illumination device in a variety of applications including, but not limited to, UV photolithography and UV spectrometry. In addition, such a microwave powered, photon-emitting plasma may be used as a photo-ionization source for devices such as, but not limited to, an ion mobility spectrometer, as discussed in detail above.

In the ion-mobility spectrometer 10 application of the invention, a sample gas 23, containing elements and compounds of interest, is introduced into the ionization chamber 24. In the ionization chamber 24, the sample gas is subject to ionizing photons 27. The sample ions 72 that are produced are then admitted to the drift region 41 of the drift tube 28 by the ion shutter grid 25. Once in the drift region 41 filled with the draft gas 39, the sample ions 72 are accelerated toward the collector electrode 34 by the uniform gradient electric field. Different ions that enter the drift region 41 at the same time will arrive at the collector electrode 34 at different times, depending on their interaction with the drift gas 39 as well as their mass-to-charge ratios. By monitoring current at the collector electrode 34 in relation to the time at which ions were admitted to the drift region 41 by the ion shutter grid 25, the identity of the sample ions 72 generated from the sample gas 23 may be determined.

Using the windowless plasma containment structure 12 to restrict the flow of the plasma-forming gas 19 away from the vent aperture 62 allows the illumination source to be operated at a pressure difference relative to the pressure of the ionization chamber that is essentially independent of the pressure of the ionization chamber 24 or the pressure of the drift tube 28. This allows increased resolution of an IMS because of the higher pressure possible in the drift region 41. Because this is accomplished with a windowless plasma containment structure 12 in which there is no window material limiting the wavelength of UV photons, the IMS resolution can also be improved by selecting which elements or compounds in the sample gas 23 are ionized. The selective ionization is accomplished by selecting the wavelength of the photons 27 emitted by the plasma. The wavelength selection is made by selecting the plasma-forming gas 19.

Although the microwave powered plasma contained by a windowless plasma containment structure 12 acting as a photon source has been discussed above primarily in connection with an IMS, such a photon source is also useful in a vacuum environment. The problem with using plasmas in a vacuum system is that the plasm-forming gas must be maintained at a pressure high enough to sustain the plasma notwithstanding the surrounding vacuum. Conventionally, a window is used to contain and isolate the plasma from the vacuum environment, but absorption by the window material limits the wavelength range of the photons 27 that can be output through the window. By using a windowless plasma containment structure 12 of the appropriate size and having an appropriate gas leak rate of a few ml/minute through the exit aperture 56, the plasma can be sustained without the need for a window that would otherwise block the ultra-violet (UV) photons 27 emitted by the plasma. With the windowless plasma containment structure 12 being small, and the exit aperture 56 also being small, the photon-emitting plasma 64 acts as a quasi-point source of illumination.

When used in a low-pressure environment, the stripline ring resonator 40 implementation shown in FIG. 5 provides an additional advantage in that the insulating layer 52 prevents sputtering of the electrodes provided by the portions of the stripline ring resonator 40 on opposite sides of the discharge gap 42. Without the protective insulating layer 52, in low pressure operation, the electrodes typically begin to sputter and the sputtered material is deposited elsewhere on the device. The sputtering may widen the discharge gap 42 to a width that makes sustaining a plasma is difficult or impossible. Moreover, the deposited sputtered material may also deposit between the backplane 50 and the stripline material and short out the device. Providing the insulating layer 52 overcomes these problems of maintaining a plasma source in a vacuum, or in a low pressure, environment.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention. Modifications may readily be devised without departing from the scope of the invention defined by the claims set forth below.

We claim:

1. An illumination device, comprising:
a stripline ring resonator defining a discharge gap;
a windowless plasma containment structure defining a plasma chamber having an inlet aperture and an outlet aperture, said inlet aperture facing said discharge gap; and
an inlet vent extending into said discharge gap, said inlet vent being capable of outputting a plasma-forming gas into said containment structure such that microwave power supplied to said stripline ring resonator converts said plasma-forming gas to a photon-emitting plasma within said plasma chamber.

2. The illumination device of claim 1, additionally comprising an insulating layer disposed on said stripline ring resonator facing said inlet aperture.

3. The illumination device of claim 1, wherein:
said illumination device additionally comprises a power source attached to said stripline ring resonator; and
said stripline ring resonator is impedance matched to said power source.

4. The illumination device of claim 1, wherein said outlet aperture is centered on said discharge gap.

5. The illumination device of claim 1, wherein said outlet aperture is smaller in diameter than said inlet aperture.

6. The illumination device of claim 5, wherein said outlet aperture has a diameter no greater than 0.3 mm.

7. The illumination device of claim 1, wherein said stripline ring resonator comprises:
a substrate having a first surface and a second surface, said first surface facing said inlet aperture, said second surface opposite said first surface;
a circular stripline on said first surface; and
a backplane on said second surface.

8. The illumination device of claim 1, wherein:
said plasma-forming gas comprises helium; and
said photon-emitting plasma emits photons having a wavelength in a range from approximately 58 nm to approximately 60 nm.

9. The illumination device of claim 1, wherein:
said plasma-forming gas comprises argon; and
said photon-emitting plasma emits photons having a wavelength in a range from approximately 104 nm to approximately 108 nm.

10. The illumination device of claim 1, wherein:
said plasma-forming gas comprises krypton; and
said photon-emitting plasma emits photons having a wavelength in a range from approximately 116 nm to approximately 125 nm.

11. The illumination device of claim 1, wherein:
said plasma-forming gas comprises xenon; and
said photon-emitting plasma emits photons having a wavelength in a range from approximately 145 nm to approximately 150 nm.

12. The illumination device of claim 1, wherein the illumination device constitutes part of an ionization source.

13. An ion-mobility spectrometer, comprising:
a stripline ring resonator defining a discharge gap;
a windowless plasma containment structure defining a plasma chamber having an inlet aperture and an outlet aperture, said inlet aperture facing said discharge gap;
an inlet vent extending into said discharge gap, said inlet vent being capable of outputting a plasma-forming gas into said containment structure such that microwave power supplied to said stripline ring resonator converts said plasma-forming gas to a photon-emitting plasma in said plasma chamber;
an ionization chamber positioned adjacent to said outlet aperture and in fluid communication with said windowless plasma containment structure;
a drift tube comprising a first end, a second end and a drift region disposed between said first and said second end, said drift tube positioned adjacent to said ionization chamber and in fluid communication therewith;
a shutter grid disposed between said ionization chamber and said drift region; and
a collector electrode disposed proximate to said second end of said drift tube.

14. The ion-mobility spectrometer of claim 13, additionally comprising a drift gas confined within said drift tube at a pressure of about atmospheric pressure.

15. The ion-mobility spectrometer of claim 13, wherein:
said plasma-forming gas comprises helium; and
said photon-emitting plasma emits photons capable of ionizing materials in said ionization chamber having an ionization potential of up to 22 eV.

16. The ion-mobility spectrometer of claim 13, wherein said plasma-forming gas comprises one of argon, krypton gas and xenon.

17. An illumination method, comprising:
providing a stripline ring resonator defining a discharge gap;
flowing a plasma-forming gas to said discharge gap;
windowlessly impeding the flow of said plasma-forming gas away from said discharge gap; and
supplying to said stripline ring resonator microwave power that converts said plasma-forming gas to a photon-emitting plasma substantially independent of pressure external to said impeded flow of said plasma-forming gas.

18. The method of claim 17, additionally comprising:
exposing a sample gas to photons emitted by said photon-emitting plasma, thereby ionizing said sample gas to produce sample ions;
measuring a transit time of said sample ions over a known path length; and,
identifying said sample ions using said transit time.
